(19) United States
(12) Patent Application Publication
(10) Pub. No.: US 2014/0165994 A1
(43) Pub. Date: Jun. 19, 2014

(54) Stovetop Water Heater

(71) Applicant: Matthew L. Porraro, Basking Ridge, NJ (US)

(72) Inventor: Matthew L. Porraro, Basking Ridge, NJ (US)

(21) Appl. No.: 14/105,268

(22) Filed: Dec. 13, 2013

Related U.S. Application Data
(60) Provisional application No. 61/738,184, filed on Dec. 17, 2012.

(51) Int. Cl. A47J 27/21

(52) U.S. Cl. CPC A47J 27/21166
USPC 126/380.1

(57) ABSTRACT

A stovetop kettle in which water is poured into an upper reservoir to pass to a lower base that includes a heat transfer structure that defines a meandering path for the water in close proximity to a heat source. Water exits the heat transfer structure at an elevated temperature and is directed through a discharge path that terminates at a discharge control valve.

### CROSS REFERENCE TO RELATED APPLICATION

This application is a non-provisional application claiming priority from co-pending U.S. Provisional Patent Application Ser. No. 61/738,184 filed Dec. 17, 2012 for Stovetop Water Heater, which application is incorporated herein by reference.

### BACKGROUND OF THE INVENTION

1. Field of the Invention

This invention generally relates to heating water and more specifically to apparatus for rapidly and efficiently heating of water on a stovetop to prepare a heated foodstuff or beverage.

2. Description of Related Art

In recent years there has developed an extensive “instant food” market in which small amounts of heated water are added to an infusible or other material, such as instant beverages including coffee, tea or hot chocolate and instant foodstuffs such as soup, oatmeal and noodles, to produce a heated consumable beverage or meal. For example, an individual who wishes to brew a cup of coffee heats water in a kettle, deposits a quantity of instant coffee crystals in a receptacle, e.g., a cup, pours the water from the kettle into the receptacle and mixes the liquid to produce a hot cup of coffee.

Typically a user heats water for such an application by pouring an arbitrary quantity of water into a kettle, often by eye. Often the amount of water in the kettle is greater than what is actually needed to make the foodstuff or beverage. The kettle is then placed on a stove to be heated until all the water boils. Normally, this heating process takes several minutes. During this time the user may shift his or her attention to another task until there is some audible indication from the kettle, such as a whistling noise, that the water is boiling. The user then removes the kettle from the stove and pours the required amount of water into the receptacle. The user may then return the kettle with unused hot water to the stovetop for later use. Recently electrified water kettles have been introduced into the marketplace to perform the same function. However, both types of kettle boil all the water in the kettle. As the amount of energy required to heat and boil all the water is greater than the amount of energy required to boil just the water that may be required, the heating process is not always efficient. In addition, such conventional and electrified water kettles are large and require corresponding counter and storage space. Electrified water kettles are also more expensive because they require an integral electrical heating device and related controls.

Still another approach for obtaining hot water involves pouring a measured amount of water into a receptacle for being heated in a microwave oven. The time required to heat the water is dependent upon the mass of the water being heated. As an example, the time required to heat a cup of water in a microwave oven may require one to two minutes or more with a corresponding consumption of energy.

What is needed is an apparatus that has a compact size, that is easy to use, that produces a desired quantity of heated water or other liquid in a minimal time and that reduces power consumption thereby to provide a serving of hot water more efficiently.

### SUMMARY

Therefore it is an object of this invention to provide an efficient kettle that quickly heats liquid on a stovetop.

Another object of this invention is to limit the quantity of water to be heated in a stovetop kettle to an amount corresponding to a quantity actually required for preparing the beverage or foodstuff.

Still another object of this invention is to provide a stovetop kettle that operates efficiently and that is easy to operate.

In accordance with one aspect of this invention, a stovetop kettle includes an upper reservoir, a lower base, and a heated water discharge path. The upper reservoir receives a quantity of water and has an outlet at the bottom thereof. The lower base has an input at the top thereof for receiving water from the upper reservoir means. A heat transfer structure closes the lower chamber and is in close proximity to an external heat source, such as a burner on a gas stove. A conduit defines a closed water path extending from the input to an output through a meandering path that is in close proximity to the external heat source. The heated water discharge path directs the heated water into the user's receptacle through a discharge control valve structure.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of one embodiment of a stovetop kettle constructed in accordance with this invention located at a burner position on a stove;

FIG. 2 is a cross-section of the stovetop kettle taken along lines 2-2 in FIG. 1 that depicts a heat transfer structure;

FIG. 3 is a bottom view of a portion of the stovetop kettle of FIGS. 1 and 2 depicting additional details of the heat transfer structure in FIG. 2;

FIG. 4 is a cross-section of another embodiment of a stovetop kettle incorporating this invention;

FIG. 5 is an enlarged cross-section view of a lower base unit used in the stovetop kettle of FIGS. 4; and

FIG. 6 depicts another configuration of a heat transfer structure that can be used in the embodiments of FIGS. 2 and 4.

### DESCRIPTION OF ILLUSTRATIVE EMBODIMENTS

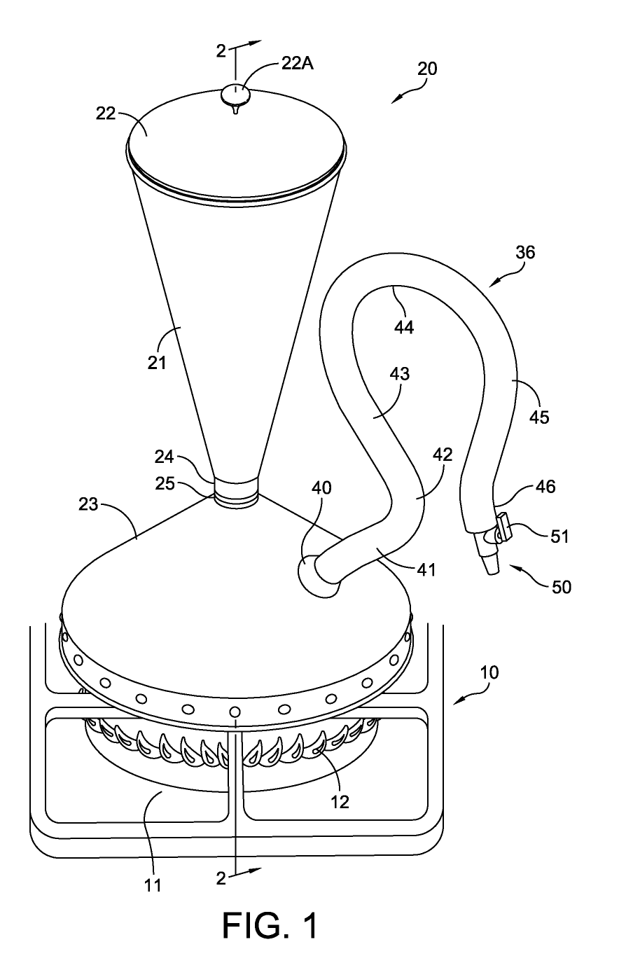

FIG. 1 depicts an external heat source in the form of a gas stove 10 with a burner position 11 and a gas flame 12. The stove 10 supports a stovetop kettle 20 constructed in accordance with this invention at the burner position 11.

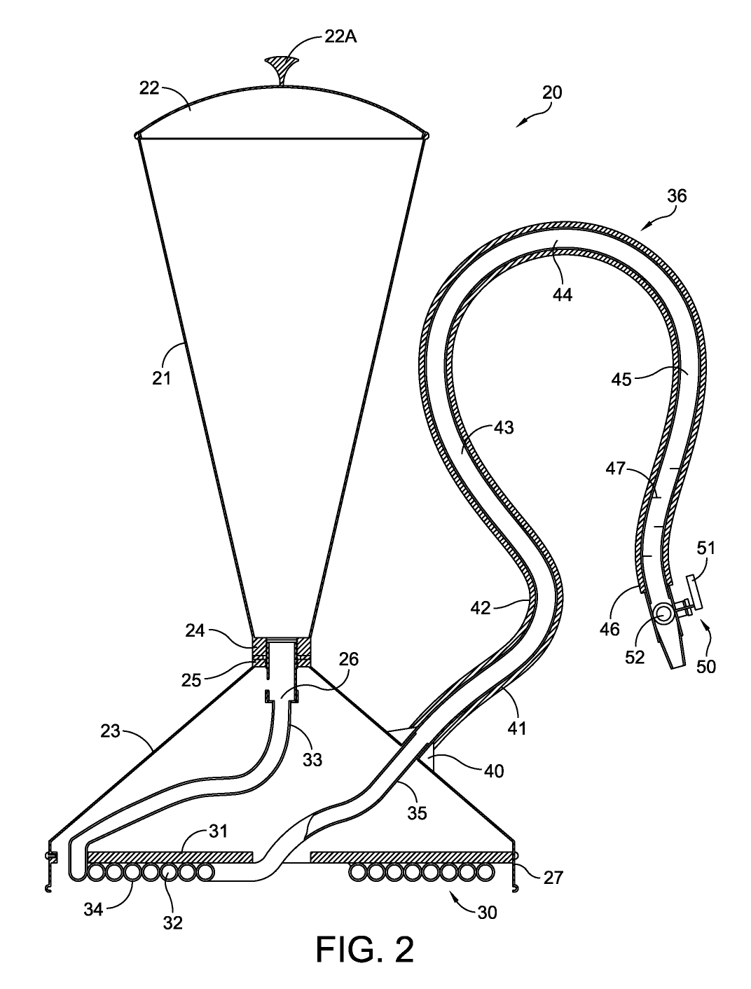

Now referring to FIGS. 1 and 2, the stovetop kettle 20 includes an upper reservoir 21, a lid 22 with a handle or knob 22A and a base 23 that forms a lower chamber. The reservoir 21 has an inverted conical shape and forms an upper chamber. The user removes the lid 22 and pours a quantity of water into the reservoir 21. This supplies water to the base 23 through a reservoir outlet 24. Other reservoir shapes could be utilized so long as water naturally drains from the upper reservoir 21 through the reservoir outlet 24 during use. For example, the overall circular profile observed from above the stovetop kettle 20 could have a polygonal or other profile.

Still referring to FIGS. 1 and 2, the lower chamber or base 23 in this embodiment has a conical cross-section. A base input 25 at the top thereof mates with the reservoir outlet 24 to provide a closed passage between the chambers through a port 26.

A bottom structure 27 at the periphery of the base 23 represents a structure that rests on the supporting surface of the gas burner position 11 in FIG. 1. The bottom structure 27 also supports a heat transfer structure 30 that includes a planar support 31 for a coil 32. The support 31 is preferably made of a material having a low heat transfer coefficient to attenuate heat transfer above the support 31 within the base 23. As with the upper reservoir 21, the base 23 could be implemented with other shapes that are complementary to the shape of the upper reservoir 21.

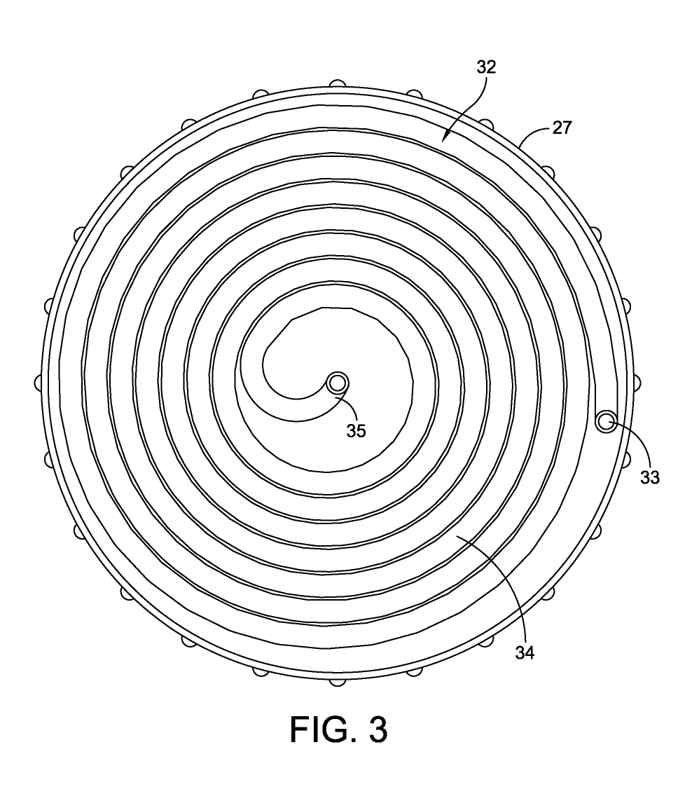

In the embodiment of FIGS. 2 and 3 the coil 32 includes an inlet end 33 that attaches to the port 26 to receive water from the upper reservoir 21 during use. An intermediate coil portion 34 located in close proximity to the gas flame 12 in FIG. 1 is routed in a meandering path that essentially lies in a plane. In this particular embodiment the intermediate coil portion 34 is wrapped in a planar spiral form. An output end 35 of the coil attaches to a discharge structure 36 at an attachment, such as a ferrule 40, on the lower base 23.

The discharge structure 36 comprises a bent tubular member with a first leg 41 extending from the ferrule 40 to an upward bend 42 and then into an inverted U-shape configuration with an upwardly extending leg 43, an inverted U-shaped section 44 and a downward leg 45 that extends to an end 46. In this particular embodiment and as shown specifically in FIG. 2, the downwardly extending leg 45 includes optional spaced hurdles 47 extending for a distance back from the end 46 to promote even flow of the liquid from a discharge control 50 that attaches to the end 46. The use of such hurdles 47 is known in the art.

Although a variety of discharge control devices might be utilized, FIGS. 1 and 2 depict a discharge control valve 50 that includes an operating handle 51 and a rotary operator 52 that moves between opened and closed positions as the rotary operator 52 aligns with the flow or is rotated 90° to block flow. Such discharge control valves are known in the art and different valve structures could be substituted for the structure shown in FIG. 1.

Still referring to FIGS. 1 and 2, and assuming that the stovetop kettle 20 is dry, as before an initial use of a new stovetop kettle, a user opens the discharge control valve 50 and then, after removing the lid 22, pours water into the reservoir 21. As the water level increases, water travels through the port 26, the intermediate coil portion 34 and the discharge structure 36 until it begins to drain from the discharge control valve 50. Then the user closes the valve 50 to block further flow and continues to fill the upper reservoir 21 until there is at least an adequate supply of water for application to the beverage or foodstuff being prepared. In one embodiment, the upper reservoir 21 is sized to hold 4 to 5 cups of water. Typically one sets the initial water level below the lid 22 and at or above the upper extent of the inverted U-shaped section 44.

If the stovetop kettle 20 is not then on the stove burner, the user moves it to that position and turns on the gas at high heat. The configuration for the heat transfer structure 30 in FIG. 2 provides an efficient heat transfer from the gas flame 12 in FIG. 1 to water in the heat transfer structure 30, specifically the intermediate coil portion 34 as the surface area contacting the water within the intermediate coil portion 34 is large relative to the volume of the water within the coil 32. That is, substantially all the heat is focused on only the water in the intermediate coil portion 34. In one embodiment, the volume of water within the planar coil 32 is about ⅓^{rd} cup. This amount of water in the coil 32, particularly the intermediate coil portion 34, quickly heats, expands and then begins to boil and produce steam. As the discharge control valve 50 is closed, steam backs through the heat transfer structure 30 to produce bubbles in the water of the upper reservoir 21 with sufficient activity to produce noise as an audible indicator that hot water can be drawn.

When this noise is heard after an initial filling of the upper reservoir 21, the user opens the discharge control valve 50 using the handle 51 and heated water begins to flow into a receptacle (not shown). This assures that there are no air blocks within the discharge control attachment 40. The user then closes the discharge control valve 50 and waits until boiling resumes whereupon the user opens the discharge valve 50 again to provide the required amount of heated water for the receptacle. After the receptacle receives the needed volume of water, the user closes the discharge control valve 50 and turns off the gas burner.

During multiple heating cycles, a hot water kettle 20 having the basic construction of FIG. 2 produced initial boiling in the range of 20 to 25 seconds. The discharge of a cup of heated water was completed within the range of 30 to 40 seconds from initial heating. The temperature of the discharged heated water in the receptacle was in the range of 78 to 85° C.

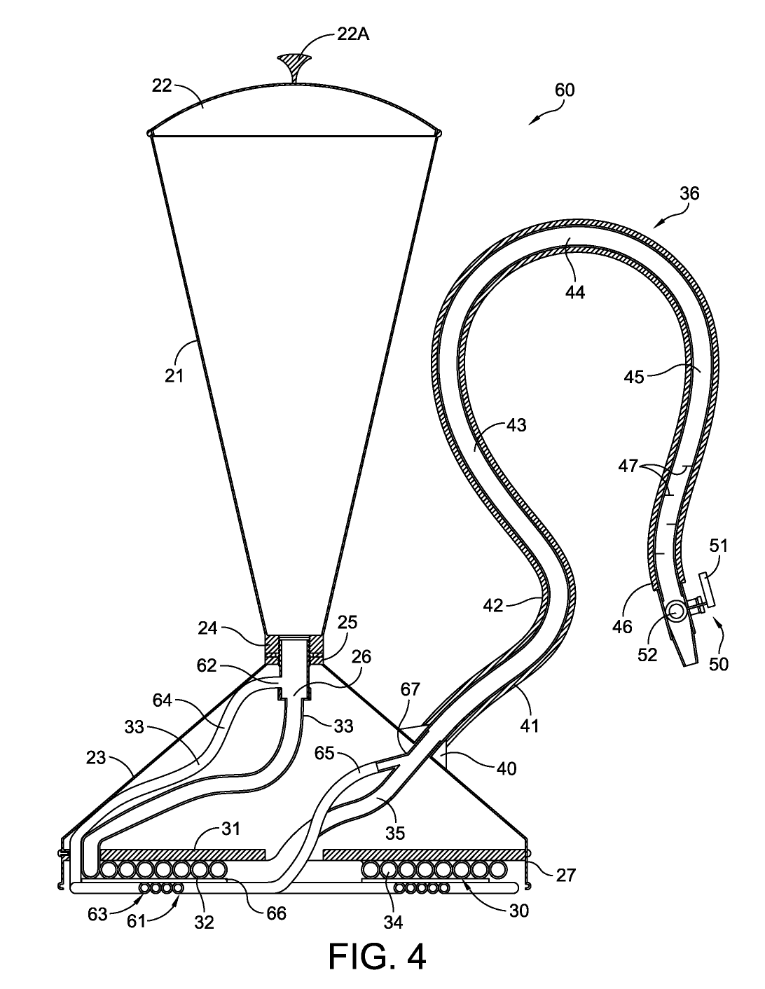

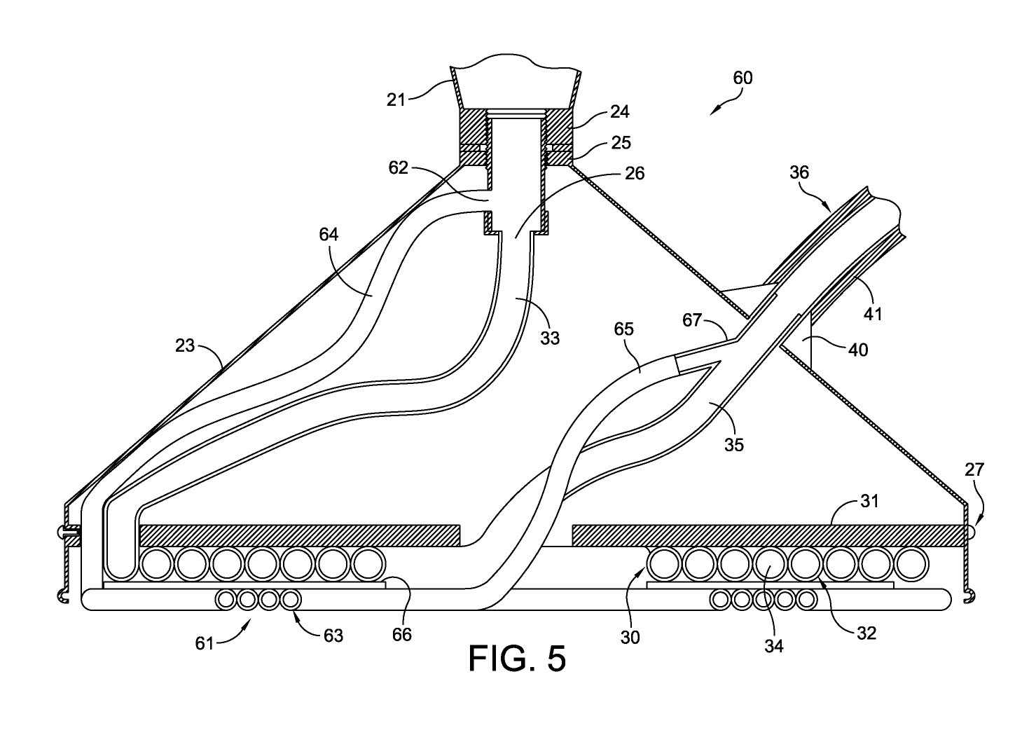

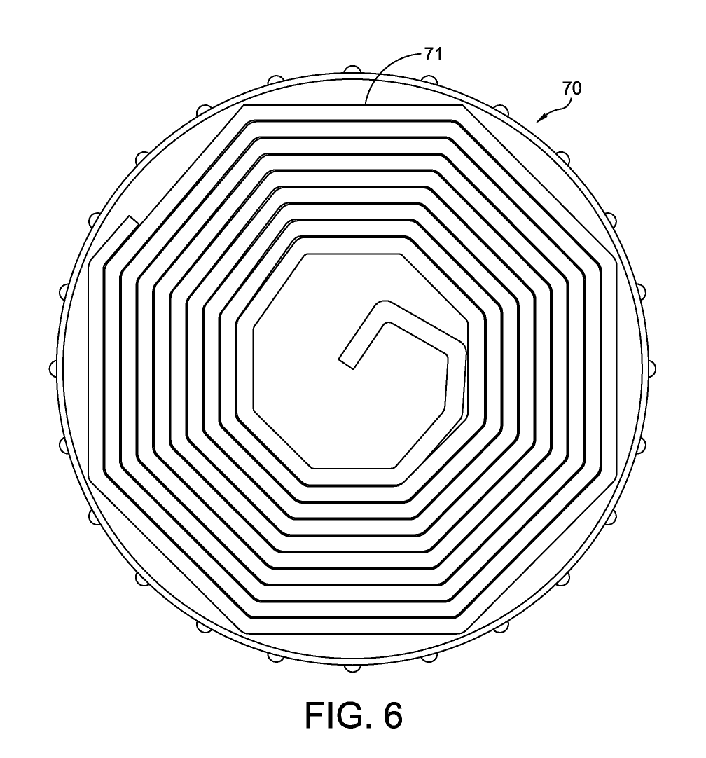

FIGS. 4 and 5 depict a second embodiment of this invention that discharges water at a higher temperature than is readily achieved by the embodiment of FIGS. 1 through 3. This second embodiment adds a secondary coil, so reference numerals from FIGS. 1 through 3 denote like components in FIGS. 4 and 5. Basically, the hot water kettle 60 in FIGS. 5 and 6 includes a second heat transfer structure 61 that acts in parallel with the first heat transfer structure 30. The addition of this second heat transfer structure 61 is accomplished by modifying the lower base inlet 25 to add a second port 62 extending through a sidewall of the lower base inlet 25. Water from the lower base inlet 25 flows through the second port 62 and a meandering path defined by an intermediate multi-turn planar coil portion 63 from a coil inlet portion 64 then to a coil output section 65. The coil portion 63 in this embodiment includes only a few turns lying in a plane and has a smaller diameter passage thereby to define a smaller volume than defined by the intermediate coil 34 in the first heat transfer structure 30. An annular mount 65 between the intermediate coils 34 and 63 supports both coils within the lower base 23. The output end of the coil 32 and the coil output section 65 attach to a Y-connection or port 67. During a heating cycle, heated fluid discharges from both the heat transfer structures 30 and 61 to comingle in the discharge structure 36 and to be directed to a receptacle through the discharge control valve 50 in FIGS. 4 and 5.

The operation of the second embodiment of FIGS. 4 and 5 is similar to that as defined with the respect to the embodiment of FIGS. 1 and 2. When a user initially fills the upper reservoir 21, the valve 50 is open until water discharges from the discharge control valve 50. The user then closes the discharge control valve 50 and begins to heat hot water kettle 60. This initial operation can occur simultaneously with the beginning of the heating cycle. As previously indicated after a short interval an audible indication of boiling will occur and heated water can now be drawn through the discharge control valve 50. When the desired quantity of water has been drawn, the discharge control valve 50 is closed and the transfer of heat to the hot water kettle 60 is terminated, as by turning the heating source off or by removing the hot water kettle from the heating source.

It has been found that the hot water kettle 60 in FIGS. 4 and 5 provides an enhanced operation because the water is hotter than the water from the hot water kettle 20 in FIGS. 1 and 3. Temperatures of the water in a receptacle from the hot water kettle 60 have been in the range of 83 to 93° C. It is believed that the temperature in the intermediate coil section 63 increases more rapidly than the temperature of the water in the intermediate coil 34 and that a portion of that water in the intermediate section 63 boils and converts to steam with its latent heat of vaporization. When the user opens the discharge control valve 50, the fluid from both coils flows under a slightly greater pressure due to the buildup of this steam in the second heat transfer structure 61. The steam exiting the second heat transfer structure 61 also comingles with the fluid leaving the heat transfer structure 30. During comingling, steam condenses and a quantity of heat corresponding to the heat of vaporization is released to effect an increase in the temperature of the mixed water. It is also postulated that a siphoning action may be initiated by the initial pressure of the steam also occurs during discharge that tends to advance water through the second heat transfer structure 61 at a greater rate than would otherwise occur and with a more constant flow from the discharge control valve 50. During operation, the time elapsed from initial heat application to initial boiling was in the range of 20 to 25 seconds and the time from the initial application of heat to the hot water kettle 60 to filling the receptacle with hot water was in the range of 30 to 40 seconds.

The embodiments in FIGS. 1 and 4 disclose heat transfer structures that utilize spiral coils. FIG. 6 is a bottom view of a hot water kettle 70 that depicts another heat transfer structure 71 with an intermediate planar coil portion that defines an octagonal meandering path. The tubing in each of the disclosed coils has a single passage. Multi-passage tubing could also be substituted. Such tubing could be formed as conventional copper or like metal tubing. In still other variations a heat transfer structure could include a tubular path formed between solid blocks or other structures that provide an efficient heat transfer from a heat source to water to be heated.

As will now be apparent, each of the disclosed embodiments and variations thereof constitutes an efficient kettle for use on a stovetop for heating water quickly and efficiently as the amount of water that is actually heated corresponds to the amount of water that is actually required by use of the consumer. Moreover, such a stovetop hot water kettle is easy to use.

This invention has been disclosed in terms of certain embodiments. It will be apparent that many modifications can be made to the disclosed apparatus without departing from the invention. Therefore, it is the intent of the appended claims to cover all such variations and modifications as come within the true spirit and scope of this invention.

What is claimed as new and desired to be secured by Letters Patent of the United States is:

1. A stovetop kettle for heating water over an external heat source and discharging the heated water into a receptacle, said stovetop kettle comprising:
A) upper reservoir means for receiving a quantity of water to be heated and having an outlet at the bottom thereof,
B) lower base means for defining a lower chamber and including:
i) input means at the top of said lower chamber for forming an input for water from said upper reservoir means outlet,
ii) base means for closing said lower chamber and for being placed over the external heat source, and
iii) coil means for defining a closed water path extending from said input means to an output through a meandering path portion attached to said base means for being heated by the external source,
C) discharge means including a discharge control valve for directing the heated water from said conduit means output into the receptacle whereby water poured into said upper chamber means passes through said coil means to be heated by the external heat source and delivered to the receptacle through said discharge means.
